(19) United States
(12) Patent Application Publication
(10) Pub. No.: US 2012/0236361 A1
(43) Pub. Date: Sep. 20, 2012

(54) PRINTING CONTROL APPARATUS, PRINT SETTING PROCESSING METHOD, AND RECORDING MEDIUM STORING DRIVER PROGRAM THEREFOR THEREIN

(75) Inventors: Noriyuki TAKEI, Shiojiri-shi (JP); Shuji WAKUMOTO, Matsumoto-shi (JP); Satoru NAKAYAMA, Shiojiri-shi (JP)

(73) Assignee: SEIKO EPSON CORPORATION, Tokyo (JP)

(21) Appl. No.: 13/419,512

(22) Filed: Mar. 14, 2012

(30) Foreign Application Priority Data
Mar. 15, 2011 (JP) 2011-056189

(51) Int. Cl. G06F 15/00

(52) U.S. Cl. 358/1.15

(57) ABSTRACT

For every execution of printing, a first print setting therefor is recorded into a log; as a result of a determination as to whether a second print setting regarding print data targeted for printing is recorded in the log, or not, if it is determined that the second print setting is recorded in the log, and further, the second print setting is not registered in a registration section, a message for advising a user to perform registration of the second print setting into the registration section is displayed; and if it is determined that the second print setting is already registered in the registration section, a message for notifying a user of a fact that the second print setting is already registered in the registration section is displayed.

### BACKGROUND

1. Technical Field

The present invention relates to a printing control apparatus, a print setting processing method, and a driver program therefor.

2. Related Art

Well-known examples of a printer driver program include a printer driver program which enables registration of repeatedly utilized print settings into a favorite menu (for example, JP-A-11-149361).

However, sometimes, existing methods for performing registration of print settings into the favorite menu are not user-friendly for users.

For example, because of insufficient user-friendliness, sometimes, there is a user who is not aware of a fact that the user's frequently utilized printer, with which the user sometimes performs printing based on the same print setting, is provided with a service enabling the user to perform registration of the print setting into a favorite menu. Moreover, sometimes, there is a user who has forgotten that the user has already performed registration of a print setting into a favorite menu in the past, and as a result, the user usually attempts to perform the same print setting again as that the user has already registered into the favorite menu.

### SUMMARY

An advantage of some aspects of the invention is to provide a technology which enables improvement of user-friendliness in performing registration of print settings.

According to an aspect of the invention, a printing control apparatus includes a log recording section configured to, for every execution of printing, record a first print setting therefor into a log; a comparison section configured to, by comparing a second print setting regarding print data targeted for printing with the first print setting recorded in the log, determine whether the second print setting is already registered in the log, or not; a registration section configured to perform registration of the second print setting into the registration section; and a message display section configured to display a message for a user in accordance with a result of the determination having been made by the comparison section, and a state regarding a registration of the second print setting into the registration section.

In the aspect of the invention, the message display section may be configured to, if the comparison section determines that the second print setting is already recorded in the log, and further, the message display section determines that the second print setting is not registered in the registration section, display a message for advising a user to perform registration of the second print setting into the registration section.

Further, in the aspect of the invention, the message display section may be configured to, if the message display section determines that the second print setting is already registered in the registration section, display a message for notifying a user of a fact that the second print setting is already registered in the registration section.

### BRIEF DESCRIPTION OF THE DRAWINGS

The invention will be described with reference to the accompanying drawings, wherein like numbers reference like elements.

FIG. 1 is a block diagram illustrating an example of an outline of a configuration of a printing system according to an embodiment of the invention.

FIG. 2 is a flowchart illustrating printing processing according to an embodiment of the invention.

FIG. 3 is a flowchart illustrating setting-content confirmation processing according to an embodiment of the invention.

FIG. 4A is a diagram illustrating an example of a screen having a message displayed thereon, which notifies that the same print setting is already registered in a favorite menu, according to an embodiment of the invention.

FIG. 4B is a diagram illustrating an example of a screen having a message displayed thereon, which notifies that a printing based on the same print setting has been performed several times in the past, according to an embodiment of the invention.

FIG. 5 is a diagram illustrating an example of an outline of a data structure of a print setting log according to an embodiment of the invention.

### DESCRIPTION OF EXEMPLARY EMBODIMENTS

Hereinafter, an embodiment according to the invention will be described with reference to drawings.

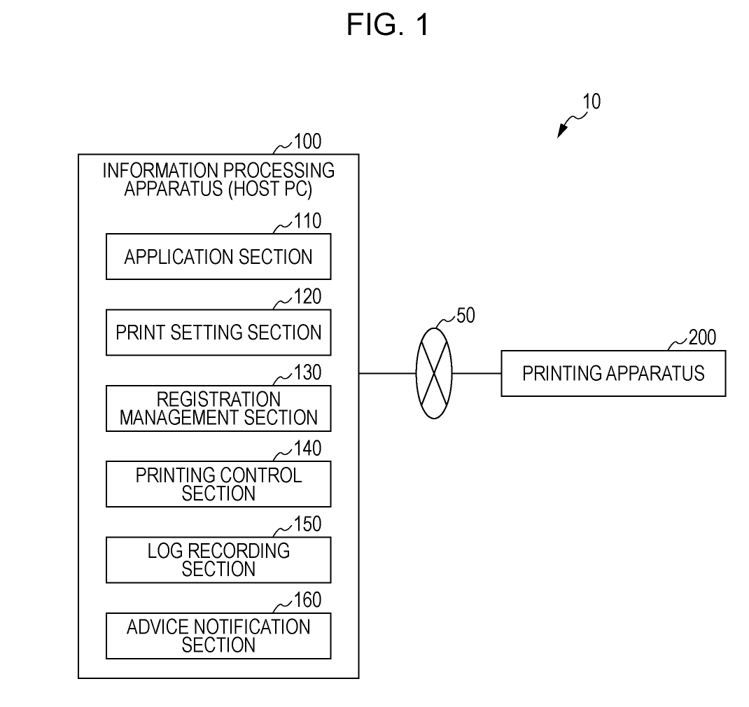

Referring to FIG. 1 which is a diagram illustrating an example of an outline of a configuration of a printing system 10 according to an embodiment of the invention, the printing system 10 includes a printing apparatus 200 and an information processing apparatus (a host PC) 100.

The printing apparatus 200 and the information processing apparatus 100 are connected to each other via a computer network 50, such as a local area network (LAN), so as to be mutually communicable. In addition, a plurality of information processing apparatus 100 may be connected to the computer network 50.

The printing apparatus 200 executes printing based on print data having been transmitted from the information processing apparatus 100. The printing apparatus 200 is a common printer which includes the following units and devices (not illustrated): a central processing unit (CPU); a main storage device, such as random access memory (RAM); an external storage device, such as read only memory (ROM) or flash memory; an operation panel (an input and output device) including input buttons, a touch panel, a liquid crystal display and the like; a communication device interfaced with the computer network 50; and a printing engine.

Configuration elements of the printing apparatus 200 are not limited to the above-described configuration elements, which are just main configuration elements thereof in description of the characteristics of the invention. Further, configuration elements of the printing apparatus 200 do not remove any different configuration element included in common printers. Moreover, the printing apparatus 200 may be replaced by a different type apparatus having a printing function, such as a multi-functional device, a scanner, or a facsimile machine.

Further, the information processing apparatus 100 functions as a host computer for the printing apparatus 200. The information processing apparatus 100 is a common computer which includes the following units and devices (not illustrated): a CPU; a main storage device, such as RAM; an external storage device, such as ROM or a hard disc; an output device including a display and the like; an input device including a keyboard, a mouse device and the like; and a communication interface for transmitting and receiving data to/from the printing apparatus 200.

Moreover, as shown in FIG. 1, the information processing apparatus 100 includes an application section 110; a print setting section 120; a registration management section 130; a printing control section 140; a log recording section 150; and an advice notification section 160. In addition, functions of the above-described function sections 110 to 160 can be realized by loading predetermined programs, such as a printer driver, to the main storage device and causing the CPU to execute the programs.

The application section 110 performs processing for creating and editing a document targeted for printing, which consists of text data, image data and the like.

The print setting section 120 performs print-setting processing in accordance with instructions from a user. For example, upon reception of an instruction for starting a print setting from a user, the print setting section 120 displays, on the output device, a print setting screen (an interface) for receiving setting instructions for respective setting items, such as a black-and-white print or a color print, a print paper size, and a double-side print or not. Further, the print setting section 120 receives setting instructions (manual instructions) for respective setting items under the state where the print setting screen remains displayed on the output device. Moreover, upon reception of an instruction for executing printing from a user, the print setting section 120 transmits setting contents related to respective setting items, which have been received from a user, to the printing control section 140, together with a document targeted for printing, which has been created by the application section 120, or a piece of data indicating a location where the document is stored.

In addition, in the case where a preset print setting registered in a favorite menu is selected, the print setting section 120 transmits contents of the selected preset print setting to the printing control section 140. Here, any print setting registered in the favorite menu (i.e., any preset print setting) includes a setting content related to at least one setting item. In addition, a method for registration of a print setting into the favorite menu will be hereinafter described.

The registration management section 130 manages the favorite menu. Specifically, the registration management section 130 performs registration into the favorite menu, edition, and deletion with respect to a print setting having been specified by a user. In addition, the registration management section 130 can allow a plurality of print settings to remain registered in the favorite menu. Further, a print setting having been registered into the favorite menu will be hereinafter referred to as “a preset print setting” as referred to above.

The printing control section 140 performs control of the printing apparatus 200 which is a destination of printing. Specifically, on the basis of a document having been created by the application section 110, the printing control section 140 creates print data, regarding which a printing is to be executed in accordance with a print setting having been specified by a user (that is, in accordance with a print setting having been transmitted from the print setting section 120). Subsequently, the printing control section 140 transmits the created print data to the printing apparatus 200 which is a destination of printing.

Every time a printing is performed (that is, every time print data is transmitted from the print control section 140 to the printing apparatus 200), the log recording section 150 records a print setting regarding print data targeted for printing (that is, a print setting having been transmitted from the print setting section 120) as a print setting log (that is, a print setting log 300 described below).

The advice notification section 160 compares a print setting regarding print data targeted for printing with each of print setting logs, and displays a message for advising a user in accordance with a comparison result.

For example, in the case where a print setting regarding print data targeted for printing is already recorded in the print setting log, the advice notification section 160 displays a message for advising a user to perform registration of the print setting.

Further, in the case where a print setting regarding print data targeted for printing (here, this print setting being not a preset print setting but a print setting having been specified by a user for individual setting items) is already registered in the favorite menu, the advice notification section 160 displays a message for notifying a user of a fact that the print setting is already registered in the menu.

Configuration elements of the information processing apparatus 100 are not limited to the above-described configuration elements, which are just main configuration elements thereof in description of the characteristics of the invention. Further, configuration elements of the information processing apparatus 100 do not remove any different configuration element included in common computers. Moreover, the information processing apparatus 100 may be replaced by a different type apparatus functioning as a host computer for the printing apparatus 200, such as a mobile terminal.

The printing system 10 according to this embodiment is configured to include such configuration elements as described above. In addition, configuration elements of the printing system 10 are not limited to the above-described configuration elements, which are just main configuration elements thereof in description of the characteristics of the invention. Further, configuration elements of the printing system 10 do not remove additions of any different configuration element.

Further, the above-described configuration elements are ones resulting from classification of a process configuration of the printing system 10 in accordance with key process contents thereof for the purpose of making it easy to understand the process configuration of the printing system 10. In addition, the scope of the invention is not limited by any way of the classification into configuration elements, and any name of the configuration elements. The process configuration of the printing apparatus 10 can be classified into a larger number of configuration elements in accordance with smaller process contents thereof. Moreover, the process configuration of the printing apparatus 10 can be classified such that each of the configuration elements can execute a larger number of processes. Furthermore, processes of each configuration element may be executed by just a hardware element, or may be executed by a plurality of hardware elements.

Next, characteristic processes of the printing system 10 configured to include such configuration elements described above will be described.

### Printing Processing

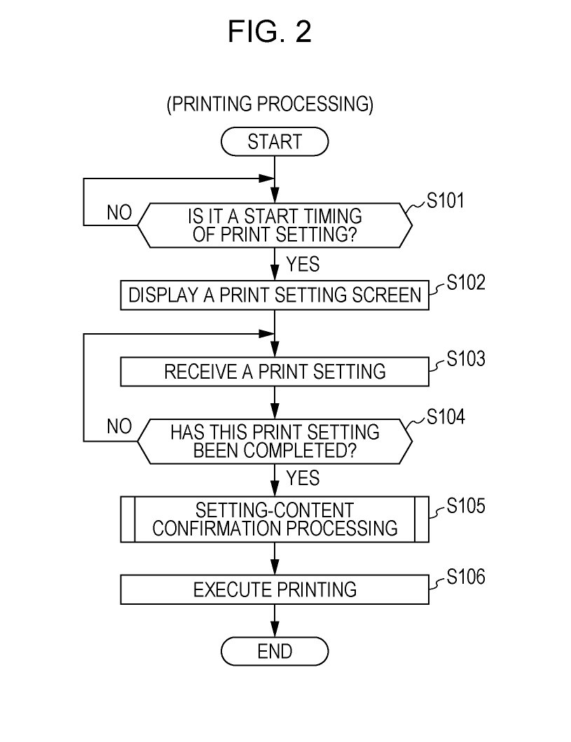

Referring to FIG. 2 which is a flowchart illustrating printing processing performed by the information processing apparatus 100, the print setting section 120 of the information processing apparatus 100 has been in a waiting condition until an occurrence of any of timings of starting a print setting (step S101; No). Here, the timings of starting a print setting include, for example, a timing at which a user executes an operation of instructing execution of printing on a screen (an interface) for creating a document targeted for printing.

Further, the print setting section 120 causes the process flow to proceed to step S102 at any of timings of starting a print setting (step S101: Yes).

The process flow has proceeded to step S102, where the print setting section 120 displays a screen for performing a pint setting (hereinafter, referred to as “a print setting screen”) on the output device, such as a display (step S102). Here, the print setting screen denotes a screen which has a function of receiving setting instructions from a user for respective setting items, such as a black-and-white print or a color print, a print paper size, or a double-side print or not, and which has a function of receiving a selection a user makes from among preset print settings.

Further, the print setting section 120 receives setting instructions from a user for respective setting items under the state where the print setting screen remains displayed on the output device (step S103).

In addition, in step S103, the print setting section 120 may receive an instruction from a user for selecting a preset print setting which is already registered in the favorite menu. In this case, for example, the print setting section 120 displays preset print setting contents of preset print settings, which are already registered in the favorite menu, on the output device in frequency-of-use order; wherein the preset print setting contents include pieces of data equivalent to ones included in setting log contents related to a favorite preset name 303 described below, respectively. Further, the print setting section 120 receives an instruction from the user for selecting any one of the preset print settings. In addition, the frequency of use denotes a total number of uses during a predetermined period of time regarding a print setting, and can be obtained by causing the print setting section 120 to, for each of the preset print settings, count the total number of uses during a period of time starting from the installation of a printer driver into the information processing apparatus 100.

Meanwhile, the print setting section 120 maintains the state of step S103 until a reception of an instruction for terminating execution of the print setting (for example, an instruction for starting executing of printing) (step S104; No).

Further, upon reception of an instruction for terminating execution of the print setting (step S104; Yes), the print setting section 120 transmits print setting contents related to respective setting items, which have been received in step S103, to the printing control section 140 together with a document targeted for printing, which has been created by the application section 120, or address data indicating a location where the document is stored, and causes the process flow to proceed to step S105.

Naturally, as described above, in the case where a preset print setting which is already registered in the favorite menu is selected in step S103, the print setting section 120 transmits preset print setting contents of the selected preset print setting to the printing control section 140.

The process flow has proceeded to step S105, where the advice notification section 160 performs processing for confirming print setting contents of the print setting having been received in step S103 (hereinafter, referred to as “setting-content confirmation processing”) (step S105). The specific content of processing performed in step S105 will be hereinafter described.

Further, subsequent to completion of the setting-content confirmation processing in step S105, the printing control section 140 performs processing for execution of printing (step S106). Specifically, on the basis of the document targeted for printing, which has been transmitted from the print setting section 120, or which is stored at a location indicated by the address data having been transmitted from the print setting section 120, the printing control section 140 creates print data such that the print data reflects contents of the print setting having been received in step S103 (that is, a print setting regarding print data targeted for printing). Subsequently, the printing control section 140 transmits the created print data to the printing apparatus 200, which is a destination of a printing based on the created print data.

At this time, the printing apparatus 200 receives the print data via the computer network 50, and executes printing based on the received print data.

Subsequent to completion of the processing in step S106, the printing control section 140 terminates this printing processing (i.e., this process flow).

Such printing processing as described above is executed by the printing system 10 according to this embodiment. Consequently, the printing system 10 according to this embodiment enables the printing apparatus 200 to, in accordance with a print setting having been specified by a user, execute printing regarding a document targeted for printing, which has been created by the information processing apparatus 100.

### Setting-Content Confirmation Processing S105

Next, the content of processing performed in step S105 of the flowchart described above will be described.

The process flow has proceeded to step S105, where the advice notification section 160, first, determines whether the print setting regarding print data targeted for printing (that is, the print setting having been received in step S103) has been selected from among the preset print settings registered in the favorite menu, or not (step S201).

Specifically, if any one of the preset print settings registered in the favorite menu has been selected in step S103, the advice notification section 160, naturally, determines that the print setting regarding print data targeted for printing has been selected from among the preset print settings registered in the favorite menu.

In contrast, if, in step S103, setting instructions have been received for respective setting items, the advice notification section 160 determines that the print setting regarding print data targeted for printing has not been selected from among the preset print settings registered in the favorite menu.

Further, if the print setting regarding print data targeted for printing has been selected from among the preset print settings registered in the favorite menu (step S201; Yes), the advice notification section 160 causes the process flow to omit the following steps S202 to S209, and jump to step S210.

Further, if the print setting regarding print data targeted for printing has not been selected from among the preset print settings registered in the favorite menu (step S201; No), the advice notification section 160 causes the process flow to proceed to step S202.

The process flow has proceeded to step S202, where the advice notification section 160 determines whether the print setting regarding print data targeted for printing (that is, the print setting having been received for individual setting items in step S103) is matched with any one of the preset print settings registered in the favorite menu, or not (step S202).

Specifically, the advice notification section 160 compares, for respective setting items, print setting contents of the print setting having been received for individual setting items in step S103 with preset print setting contents of each of the preset print settings registered in the favorite menu. Further, if, for the respective setting items for which the comparison has been made, the print setting contents are matched with the preset print setting contents of any one of the preset print settings registered in the favorite menu, the advice notification section 160 determines that the print setting regarding print data targeted for printing is matched with the preset print setting registered in the favorite menu. In contrast, if, for at least one of the setting items for which the comparison has been made, a corresponding print setting content is different from a corresponding preset print setting content of any of the preset print settings registered in the favorite menu, the advice notification section 160 determines that the print setting regarding print data targeted for printing is not matched with any of the preset print settings registered in the favorite menu.

Further, if the print setting regarding print data targeted for printing is matched with any one of the preset print settings registered in the favorite menu (step S202; Yes), the advice notification section 160 causes the process flow to proceed to step S211.

In this case, for the user, selecting any one of the preset print settings registered in the favorite menu results in a simpler operation than setting print setting contents for respective setting items. Therefore, when the process flow has proceeded to step S211, the advice notification section 160 provides the user with a message for advising that selecting from among the preset print settings registered in the favorite menu can provide the user with a more prompt print setting (step S211). Specifically, the advice notification section 211 displays, on the output device, such as a display, a message for notifying that the same print setting is already registered in the favorite menu.

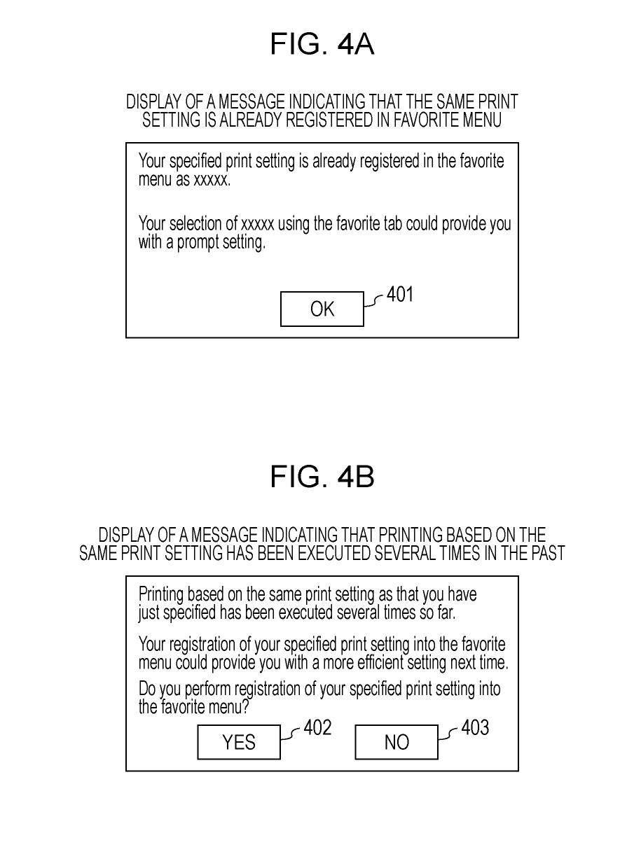

FIG. 4A is a diagram illustrating an example of a screen having a message displayed thereon, which notifies that the same print setting is already registered in the favorite menu. As shown in FIG. 4A, the advice notification section 160 displays a message, such as “Your specified print setting is already registered in the favorite menu as xxxxx. Your selection of xxxxx using the favorite tab could provide you with a prompt setting.” on the output device in step S211. Along therewith, as shown in FIG. 4A, the advice notification section 160 displays an OK button 401 to confirm that the user has recognized the message.

Here, upon reception of an operation of touching the OK button 401, the advice notification section 160 causes the process flow to proceed to step S210.

Meanwhile, if, in step S202, the print setting regarding print data targeted for printing is not matched with any of the preset print settings registered in the favorite menu (step S202; No), the advice notification section 160 causes the process flow to proceed to step S203.

In this case, the advice notification section 160 compares the print setting regarding print data targeted for printing with the print setting log 300 (step S203). Specifically, the advice notification section 160 compares, for respective setting items, the print setting contents of the print setting having been received in step S103 with setting log contents of the print setting log 300 stored in a predetermined storage device.

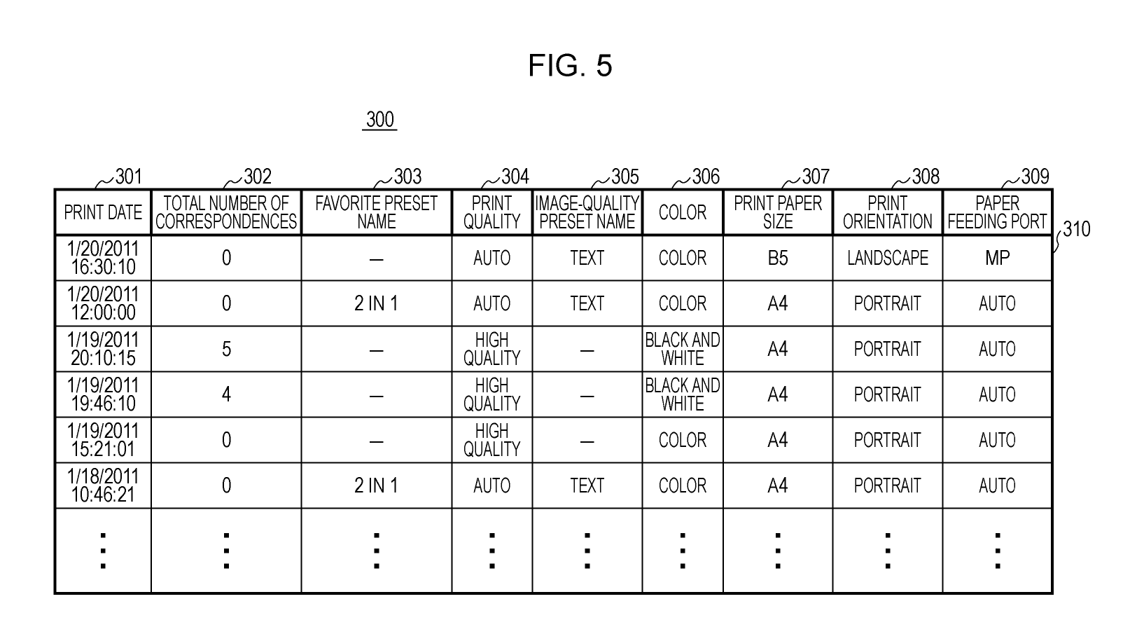

Referring to FIG. 5 which is a diagram illustrating an example of an outline of a data structure of the print setting log 300, the print setting log 300 includes records 310, each of which is recorded every time a printing is executed (that is, every time print data is transmitted). Further, setting log contents related to respective setting items are integrated and stored into each of the records 310; wherein the setting items are a print date 301, a total number of correspondences 302, a favorite preset name 303, a print quality 304, an image-quality preset name 305, a color 306, a print paper size 307, a print orientation 308, and a paper feeding port 309.

A setting log content related to the print date 301 includes a piece of data indicating a date at which a corresponding printing has been executed (that is, a date at which corresponding print data has been transmitted). For example, the setting log content related to the print date 301 includes a string of characters having a format, such as “year/month/day time of day”.

A setting log content related to the total number of correspondences 302, the setting log content corresponding to each of the records 310, includes a piece of data indicating the number of occurrences of an event at which, for the respective setting items 304 to 309, when print setting contents regarding print data targeted for printing are compared with setting log contents corresponding to the record 310, the print setting contents regarding print data targeted for printing are matched with the setting log contents corresponding to the record 310. For example, the setting log content related to the total number of correspondences 302 includes a string of characters, such as “four times”.

A setting log content related to the favorite preset name 303, the setting log content corresponding to each of the records 310, includes a piece of data indicating a name of setting log contents which are related to the respective setting items 304 to 309, and which correspond to the record 310. For example, the setting log content related to the favorite preset name 303 includes a string of characters, such as “2 in 1”.

A setting log content related to the print quality 304 includes a piece of data indicating a quality (resolution) of printing having been specified prior to execution of printing. For example, the setting log content related to the print quality 304 includes a string of characters, such as “AUTO” or “HIGH QUALITY”.

A setting log content related to the image quality preset name 305 includes a piece of data indicating an image quality of printing having been specified prior to execution of printing. For example, the setting log content related to the image quality preset name 305 includes a string of characters, such as “TEXT” or “PICTURE”.

A setting log content related to the color 306 includes a piece of data indicating a kind of color having been specified prior to execution of printing. For example, the setting log content related to the color 306 includes a string of characters, such as “COLOR” or “BLACK AND WHITE”.

A setting log content related to the print paper size 307 includes a piece of data indicating the size of print paper having been specified prior to execution of printing. For example, the setting log content related to the print paper size 307 includes a string of characters, such as “A4” or “B5”.

A setting log content related to the print orientation 308 includes a piece of data indicating an orientation of printing having been specified prior to execution of printing. For example, the setting log content related to the print orientation 308 includes a string of characters, such as “LANDSCAPE” or “PORTRAIT”.

A setting log content related to the paper feeding port 309 includes a piece of data indicating a paper feeding port having been selected prior to start of printing. For example, the setting log content related to the paper feeding port 309 includes a string of characters, such as “AUTO” or “MP”.

In step S203, the advice notification section 160 retrieves each of the records recorded in the print setting log 300 described above from the predetermined storage device, and compares the record with the print setting regarding print data targeted for printing.

Here, if, in the print setting log 300, there does not exist any record 310 including setting log contents that are matched with respective print setting contents of the print setting regarding print data targeted for printing; wherein, in the example shown in FIG. 5, the setting log contents are ones related to the respective setting items, which are the print quality 304, the image quality preset name 305, the color 306, the print paper size 307, the print orientation 308, and the paper feeding port 309, the advice notification section 160 determines that the print setting regarding print data targeted for this printing has never been used in the past. In this case, the advice notification section 160 omits the following processes of steps S205 to S209, and causes the process flow to jump to step S210.

In contrast, if, in the print setting log 300, there exists any record 310 including setting log contents that are matched with respective print setting contents of the print setting regarding print data targeted for printing, the setting log contents being ones related to the respective setting items 304 to 309, the advice notification section 160 determines that the print setting regarding print data targeted for this printing has ever been used in the past. In this case, the advice notification section 160 causes the process flow to proceed to step S205.

The process flow has proceeded to step S205, where the advice notification section 160 increments by one a setting log content related to the total number of correspondences 302; wherein the setting log content is caused to correspond to setting log contents which are related to the respective setting items 304 to 309, and which are matched with respective print setting contents of the print setting regarding print data targeted for printing (step S205).

Further, the advice notification section 160 determines whether a number of times included in the setting log content related to the total number of correspondences 302, which has been incremented in step S205, is more than or equal to a predetermined number of times (for example, five times), or not (step S206).

Here, if a number of times included in the setting log content related to the total number of correspondences 302 is less than a predetermined number of times (step S206; No), the advice notification section 160 omits the following processes of steps S207 to S209, and causes the process flow to jump to step S210.

In contrast, if a number of times included in the setting log content related to the total number of correspondences 302 is more than or equal to a predetermined number of times (step S206; Yes), the advice notification section 160 determines that the print setting regarding print data targeted for this printing has ever been used several times in the past, and causes the process flow to proceed to step S207.

The process flow has proceeded to step S207, where the advice notification section 160 provides the user with a message for advising that the user's registration of the print setting having been used several times into the favorite menu can provide the user with a more efficient print setting (step S207). Specifically, the advice notification section 211 displays a message for notifying that a printing based on the same print setting has been performed several times in the past on the output device, such as a display. In this way, the advice notification section 160 can advise the user to perform registration of the print setting, which has been used several times, into the favorite menu.

FIG. 4B is a diagram illustrating an example of a screen including a message displayed thereon, which notifies that a printing based on the same print setting has been performed several times in the past. As shown in FIG. 4B, in step S207, the advice notification section 160 displays, on the output device, a message, such as “Printing based on the same print setting as that you have just specified has been executed several times so far. Your registration of your specified print setting into the favorite menu could provide you with a more efficient setting next time. Do you perform registration of your specified print setting into the favorite menu?”.

Along therewith, the advice notification section 160 displays an “YES” button 402 and a “NO” button 403, such as shown in FIG. 4B, to receive an instruction from the user for indicating whether the user has the will to perform registration into the favorite menu, or not (step S208).

Here, if the advice notification section 160 has received an operation of touching the “NO” button 403 (step S208; No), the advice notification section 160 does not execute processing for registration into the favorite menu, and causes the process flow to proceed to step S210.

In contrast, if the advice notification section 160 has received an operation of touching the “YES” button 402 (step S208; Yes), the advice notification section 160 causes the process flow to proceed to step S209 to execute processing for registration into the favorite menu.

The process flow has proceeded to step S209, where the registration management section 130 executes processing for registration of the print setting regarding print data targeted for printing (that is, the print setting having been received in step S103) into the favorite menu (step S209).

Specifically, the registration management section 130 creates a preset print setting by integrating preset print setting contents corresponding thereto, and stores the created preset print setting into a predetermined storage device, wherein the preset print setting contents are a name of this preset print setting targeted for registration, the name being indicated by, for example, a piece of data equivalent to that of a setting log content related to the favorite preset name 303; preset setting contents that are indicated by pieces of data equivalent to those of setting log contents related to respective setting items, such as the print quality 304, the image quality preset name 305, the color 306, the print paper size 307, the print orientation 308, and the paper feeding port 309; and a total number of uses.

Subsequently, the registration management section 130 causes the process flow to proceed to step S210.

The process flow has proceeded to step S210, where the log recording section 150 records the print setting regarding print data targeted for printing (that is, the print setting having been received in step S103) into the print setting log 300 (step S210).

Specifically, the log recording section 150 creates a record 310 by acquiring a current time of day to make it a setting log content related to the print data 301; setting a setting log content related to the total number of correspondences 302 to “0”; and making setting log contents related to the respective setting items, which are the print quality 304, the image quality preset name 305, the color 306, the print paper size 307, the print orientation 308 and the paper feeding port 309, equal to corresponding print setting contents of the print setting having been specified in step S103, and then, records the created record 310 into the print setting log 300. Here, in the case where the print setting targeted for recording is already named, the log recording section 150 creates the record 310 by additionally making a setting log content related to the favorite preset name 303 equal to the name, and then, records the created record 310 into the print setting log 300.

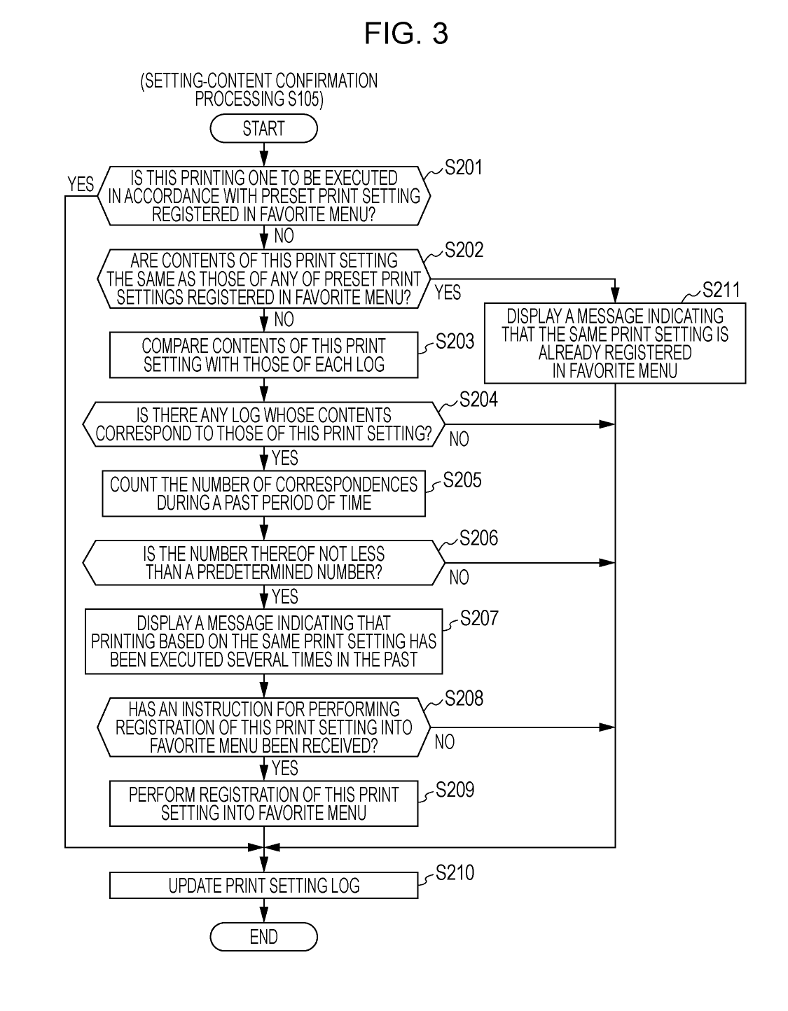

Subsequently, the log recording section 150 terminates this processing (i.e., the setting-content confirmation processing step S105 shown in FIG. 3), and returns the process flow to step S106 of the processing described above (i.e., the printing processing shown in FIG. 2).

In such a way as described above, in the information processing apparatus 100 according to this embodiment, it is possible to advise a user, who frequently performs printing based on the same print setting, to perform registration of the print setting into the favorite menu. Moreover, in the information processing apparatus 100 according to this embodiment, in the case where, although a user has already performed registration of a print setting into the favorite setting in the past, the user has performed print setting of contents related to respective setting items again without using the already registered print setting, it is possible to recommend the user to, when performing printing next time, use the print setting which is already registered in the favorite menu.

Accordingly, in the information processing apparatus 100 according to this embodiment, it is possible to improve user-friendliness in registration of print settings.

In addition, individual process units in each of the process flows according to the above-described embodiment are ones resulting from segmentation of processing of the printing system 10 in accordance with key process contents thereof for the purpose of making it easy to understand the processing of the printing system 10. The scope of the invention is not limited by any way of the segmentation into process steps, and any name of the process steps. The processing performed by the printing apparatus 10 can be segmented into a larger number of process steps. Moreover, each of the process steps may execute a larger number of processes. Furthermore, an order in which the process steps are executed is not limited to that according to this embodiment, but can be changed to the full extent possible.

In addition, the above-described embodiment is intended to exemplify the gist of the invention, and does not limit the scope of the invention. Lots of alternatives, modifications and changes are obvious for those skilled in the art.

For example, in the print setting log 300 according to the above-described embodiment, setting log contents related to respective setting items are recorded; wherein the setting items are the print quality 304, the image quality preset name 305, the color 306, the print paper size 307, the print orientation 308, and the paper feeding port 309. However, the invention is not limited to these setting items. For example, any different setting item, such as, double-side print or not, may be added to the above-described setting items regarding the print settings to be recorded in the print setting log 300, and further, any of the above-described setting items may be deleted.

Further, in the case where, in step S209 of the above-described embodiment, any print settings cannot be registered because of a storage capacity shortage, the registration management section 130 may delete already registered print settings each having a low frequency of use from the favorite menu. In this way, it is possible to resolve an issue due to the storage capacity shortage, and further, it is possible to limit print settings which remain registered in the favorite menu to ones each having a high frequency of use.

Further, in the above-described embodiment, in step S206, the advice notification section 160 determines whether a number of times indicated by the setting log content related to the total number of correspondences 302 is more than or equal to a predetermined number of times (for example, five times), or not, but this predetermined number of times may be made equal to “0”.

The entire disclosure of Japanese Patent Application No. 2011-056189, filed Mar. 15, 2011 is expressly incorporated by reference herein.

What is claimed is:

1. A printing control apparatus comprising:
a log recording section configured to, for every execution of printing, record a first print setting therefor into a log;
a comparison section configured to, by comparing a second print setting regarding print data targeted for printing with the first print setting recorded in the log, determine whether the second print setting is already registered in the log, or not;
a registration section configured to perform registration of the second print setting into the registration section; and
a message display section configured to display a message for a user in accordance with a result of the determination having been made by the comparison section, and a state regarding a registration of the second print setting into the registration section.

2. The printing control apparatus according to claim 1, wherein the message display section is configured to, if the comparison section determines that the second print setting is already recorded in the log, and further, the message display section determines that the second print setting is not registered in the registration section, display a message for advising a user to perform registration of the second print setting into the registration section.

3. The printing control apparatus according to claim 1, wherein the message display section is configured to, if the message display section determines that the second print setting is already registered in the registration section, display a message for notifying a user of a fact that the second print setting is already registered in the registration section.

4. The printing control apparatus according to claim 1, wherein the message display section is configured to display the already registered second print setting in frequency-of-use order.

5. The printing control apparatus according to claim 1, wherein the printing control apparatus is configured to, in the case where a registration of the second print setting is blocked because of a storage capacity shortage of the registration section, delete the already registered second print setting having a low frequency of use.

6. A print setting processing method comprising:
recording, for every execution of printing, a first print setting therefor into a log;
comparing a second print setting regarding print data targeted for printing with the first print setting recorded in the log to determine whether the second print setting is already recorded in the log, or not;
determining whether the second print setting is already registered in a registration section, or not; and
displaying a message for notifying a user of a fact that the second print setting is already registered in the registration section if it is determined that the second print setting is already registered in the registration section.

7. A recording medium storing a driver program therein which is executed by a computer, and which causes the computer to function as a printing control apparatus, the driver program comprising:
recording, for every execution of printing, a first print setting therefor into a log;
comparing a second print setting regarding print data targeted for printing with the first print setting recorded in the log to determine whether the second print setting is already recorded in the log, or not;
determining whether the second print setting is already registered in a registration section, or not; and
displaying a message for advising a user to perform registration of the second print setting into the registration section if it is determined that the second print setting is already recorded in the log, and further, the second print setting is not registered in the registration section, and displaying a message for notifying a user of a fact that the second print setting is already registered in the registration section if it is determined that the second print setting is already registered in the registration section.
